(19) United States
(12) Patent Application Publication
(10) Pub. No.: US 2015/0072128 A1
(43) Pub. Date: Mar. 12, 2015

(54) FLOURINE-CONTAINING HIGHLY BRANCHED POLYMER AND POLYCARBONATE RESIN COMPOSITION CONTAINING THE SAME

(71) Applicant: NISSAN CHEMICAL INDUSTRIES, LTD., Tokyo (JP)

(72) Inventors: Motonobu Matsuyama, Funabashi-shi (JP); Masayuki Haraguchi, Funabashi-shi (JP); Masaaki Ozawa, Funabashi-shi (JP)

(21) Appl. No.: 14/394,848

(22) PCT Filed: Apr. 12, 2013
(86) PCT No.: PCT/JP2013/061072

§ 371 Date: Oct. 16, 2014

(30) Foreign Application Priority Data
Apr. 16, 2012 (JP) 2012-093297

(51) Int. Cl. C08F 220/24; C09D 169/00; C09D 135/02; C08L 69/00; C08F 222/10; C09D 133/16

(52) U.S. Cl. CPC C08F 220/24; C08F 222/1006; C09D 133/16; C09D 135/02; C08L 69/00; C09D 169/00; C08F 2222/102
USPC 428/220; 526/245; 524/544; 525/185; 524/502; 427/385.5

(57) ABSTRACT

There is provided a novel fluorine-containing highly branched polymer which imparts water repellency and oil repellency to the polycarbonate resin, further is excellent in miscibility and dispersibility in the resin, and can maintain luxurious feeling of the resin, such as transparency and gloss feeling. A fluorine-containing highly branched polymer obtained by polymerizing a monomer A having in a molecule a bisphenol A structure and two or more radical-polymerizable double bonds, and a monomer B having in a molecule a fluoroalkyl group and at least one radical-polymerizable double bond, in the presence of a polymerization initiator C in an amount of 5 to 200 mol %, based on the number of moles of the monomer A; a resin composition comprising the fluorine-containing highly branched polymer and a polycarbonate resin; and a surface-modified film obtained from the resin composition.

### TECHNICAL FIELD

The present invention relates to a fluorine-containing highly branched polymer, a polycarbonate resin composition containing the polymer, and a surface-modified film obtained from the resin composition.

### BACKGROUND ART

Polymer (macromolecular) materials have been increasingly utilized in various fields lately. Consequently, according to each field, the characteristics of the surface or the interface of the polymer have become important in addition to the properties of the polymer as a matrix. For example, the use of a fluorine-based compound having a low surface energy as a surface modifier can expect improvement in the characteristics with respect to the surface/interface control, such as water and oil repellency, antifouling properties, non-adhesiveness, peeling properties, mold releasability, sliding properties, wear resistance, antireflection characteristics, and chemical resistance. Various surface modifiers have been developed.

A polycarbonate resin that is one of engineering plastics is a resin excellent in heat resistance, mechanical properties, optical characteristics, and electrical characteristics and is widely utilized, for example, for automotive materials, materials for electric/electronic instruments, housing materials, and materials for producing parts in other industrial fields. In particular, a polycarbonate resin composition to which flame retardancy is imparted is suitably utilized as members for OA/information instruments such as computers, notebook personal computers, cellular phones, printers, and copiers; seats; and film members.

In such various applications, for the purpose of enhancing the product value, a method is known in which a polycarbosilane compound is blended in the resin for modifying surface characteristics such as water repellency, antifog properties, antifouling properties, dirt removability, humidity resistance, lubricity, wear resistance, mold releasability, chemical resistance, and scratch resistance (Patent Document 1). Furthermore, a technique is disclosed in which surface characteristics are imparted to the resin by applying a urethane-based coating agent containing a compound having a polysiloxane (silicone) skeleton and a fluoroalkyl group (Patent Document 2).

### RELATED-ART DOCUMENTS

### Patent Documents

Patent Document 1: Japanese Patent Application Publication No. 2010-270297 (JP 2010-270297 A)

Patent Document 2: Japanese Patent Application Publication No. 2010-222559 (JP 2010-222559 A)

### SUMMARY OF THE INVENTION

### Problem to be Solved by the Invention

However, the anti-fouling measures disclosed in Patent Document 1 still have the disadvantages that sufficient oil repellency cannot be imparted and organic solvents or oil stains are unlikely to be removed. In addition, the method disclosed in Patent Document 2 requires a step of applying a coating liquid, which is disadvantageous in the industrial production.

Further, a fluorine-containing polymer is poor in dispersibility in a polycarbonate resin, and it is regarded as problematic that the gloss feeling after the application is impaired, so that a material that does not impair the optical characteristics of the polycarbonate has been required.

### Means for Solving the Problem

As a result of assiduous research intended to attain the above object, the inventors of the present invention have found the followings. The use of fluorine-based materials has been hardly studied from the viewpoint of the low compatibility as a surface modifying material with a polycarbonate resin. By adopting a novel fluorine-containing highly branched polymer among the fluorine-based materials as a surface modifier, the fluorine-containing highly branched polymer can impart water repellency and oil repellency to the polycarbonate resin, further is excellent in miscibility and dispersibility in the resin, and can maintain luxurious feeling of the resin, such as transparency and gloss feeling. The inventors have thus completed the present invention.

Specifically, the present invention relates to, according to a first aspect, a fluorine-containing highly branched polymer obtained by polymerizing a monomer A having in a molecule a bisphenol A structure and two or more radical-polymerizable double bonds, and a monomer B having in a molecule a fluoroalkyl group and at least one radical-polymerizable double bond, in the presence of a polymerization initiator C in an amount of 5 to 200 mol %, based on the number of moles of the monomer A.

The present invention relates to, according to a second aspect, the fluorine-containing highly branched polymer according to the first aspect, in which the monomer A is a compound having either a vinyl group or a (meth)acrylic group or both a vinyl group and a (meth)acrylic group.

The present invention relates to, according to a third aspect, the fluorine-containing highly branched polymer according to the second aspect, in which the monomer A is a divinyl compound or a di(meth)acrylate compound.

The present invention relates to, according to a fourth aspect, the fluorine-containing highly branched polymer according to the third aspect, in which the monomer A is a compound of Formula [1]:

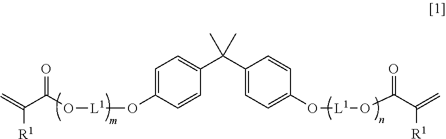

(where R¹ is a hydrogen atom or a methyl group; L¹ are independently a C₁₋₆ alkylene group; and m and n are independently an integer of 0 to 30).

The present invention relates to, according to a fifth aspect, the fluorine-containing highly branched polymer according to the first aspect, in which the monomer B is a compound having at least one of either a vinyl group or a (meth)acrylic group.

The present invention relates to, according to a sixth aspect, the fluorine-containing highly branched polymer according to the fifth aspect, in which the monomer B is a compound of Formula [2]:

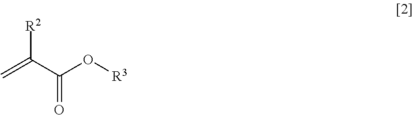

(where R² is a hydrogen atom or a methyl group; and R³ is a C₂₋₁₂ fluoroalkyl group optionally substituted with a hydroxy group).

The present invention relates to, according to a seventh aspect, the fluorine-containing highly branched polymer according to the sixth aspect, in which the monomer B is a compound of Formula [3]:

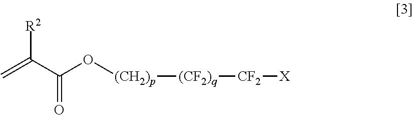

(where R² means the same as defined in Formula [2]; X is a hydrogen atom or a fluorine atom; and p is 1 or 2; and q is an integer of 0 to 5).

The present invention relates to, according to an eighth aspect, the fluorine-containing highly branched polymer according to the first aspect, in which the monomer A is a compound of Formula [1] and the monomer B is a compound of Formula [2]:

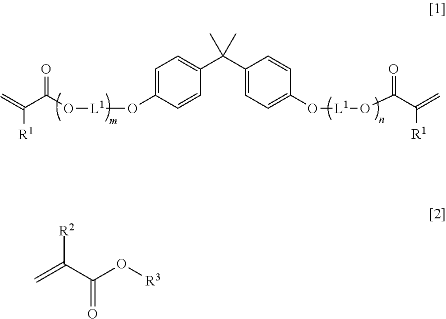

(where R¹ and R² are independently a hydrogen atom or a methyl group; R³ is a C₂₋₁₂ fluoroalkyl group optionally substituted with a hydroxy group; L¹ independently a C₁₋₆ alkylene group; and m and n are independently an integer of 0 to 30).

The present invention relates to, according to a ninth aspect, the fluorine-containing highly branched polymer according to the first aspect, in which the polymerization initiator C is an azo-based polymerization initiator.

The present invention relates to, according to a tenth aspect, the fluorine-containing highly branched polymer according to the ninth aspect, in which the polymerization initiator C is dimethyl 2,2′-azobisisobutyrate or 2,2′-azobis(2-methylbutyronitrile).

The present invention relates to, according to an eleventh aspect, the fluorine-containing highly branched polymer according to any one of the first aspect to the tenth aspect, in which the fluorine-containing highly branched polymer is obtained by using the monomer B in an amount of 5 to 300 mol %, based on the number of moles of the monomer A.

The present invention relates to, according to a twelfth aspect, a varnish comprising: the fluorine-containing highly branched polymer as described in any one of the first aspect to the eleventh aspect.

The present invention relates to, according to a thirteenth aspect, a thin film comprising: the fluorine-containing highly branched polymer as described in any one of the first aspect to the eleventh aspect.

The present invention relates to, according to a fourteenth aspect, a method for modifying a surface of a polycarbonate resin, the method comprising: kneading the fluorine-containing highly branched polymer as described in any one of the first aspect to the eleventh aspect with the polycarbonate resin, or coating the surface of the resin with the fluorine-containing highly branched polymer.

The present invention relates to, according to a fifteenth aspect, a resin composition comprising: (a) the fluorine-containing highly branched polymer as described in any one of the first aspect to the eleventh aspect; and (b) a polycarbonate resin.

The present invention relates to, according to a sixteenth aspect, the resin composition according to the fifteenth aspect, in which a content of (a) the fluorine-containing highly branched polymer is 0.01 to 20 parts by mass, relative to 100 parts by mass of (b) the polycarbonate resin.

The present invention relates to, according to a seventeenth aspect, the resin composition according to the sixteenth aspect, further comprising (c) a solvent.

The present invention relates to, according to an eighteenth aspect, a surface-modified film obtained from the resin composition as described in any one of the fifteenth aspect to the seventeenth aspect.

The present invention relates to, according to a nineteenth aspect, the surface-modified film according to the eighteenth aspect, in which the surface-modified film has a film thickness of 0.1 to 100 μm.

The present invention relates to, according to a twentieth aspect, a method for forming a surface-modified film, the method comprising: coating a surface of a base material with the resin composition as described in the seventeenth aspect to form a coating film; and drying the coating film to remove the solvent.

The present invention relates to, according to a twenty-first aspect, the method according to the twentieth aspect, in which the surface-modified film has a film thickness of 0.1 to 100 μm.

### Effects of the Invention

The fluorine-containing highly branched polymer of the present invention has a highly branched structure, and thus, contains little entanglement between the molecules in comparison with linear polymers, exhibits a behavior like fine particles, and has high solubility in an organic solvent and high dispersibility in a resin. Because of this, when the fluorine-containing highly branched polymer of the present invention is blended in a resin to form a molded body, the highly branched polymer in a fine particle shape moves easily to the interface (the surface of the molded body), which leads to enhancement of the surface modification of the resin surface.

In particular, the fluorine-containing highly branched polymer of the present invention can be produced as a fluorine-containing highly branched polymer in which the affinity with a polycarbonate resin and the dispersibility in a polycarbonate resin are enhanced by introducing a bisphenol A structure into the backbone of the polymer. Thus, when the fluorine-containing highly branched polymer is blended in a polycarbonate resin composition and the resultant polycarbonate resin composition is molded to a resin molded article, a water and oil repellent molded body can be obtained without impairing transparency of the polycarbonate. A film formed from the polycarbonate resin composition in which the fluorine-containing highly branched polymer is blended is formed as a film in which water and oil repellency is imparted to a resin film obtained from the resin without impairing the inherent transparency of the resin. Further, by coating the surface of the polycarbonate resin with the fluorine-containing highly branched polymer, such a surface modifying effect as capable of imparting water and oil repellency to the surface of the polycarbonate resin can be obtained.

Moreover, when the polycarbonate resin composition in which the fluorine-containing highly branched polymer of the present invention is blended is molded to resin molded articles including films, the resin molded article is in a state where the fluorine-containing highly branched polymer exists in a large amount in the surface (interface) of the molded article in comparison with that in the internal portion (deep portion) of the molded article. Therefore, the resin molded article can be produced as a resin molded article excellent in mold releasability relative to various machines such as a mixing machine and a molding machine, and a mold, and in peeling properties relative to other resin molded articles such as films.

### BRIEF DESCRIPTION OF THE DRAWINGS

FIG. 1 is a graph showing the ¹³C NMR spectrum of a highly branched polymer 1 obtained in Example 1.

FIG. 2 is a graph showing the ¹³C NMR spectrum of a highly branched polymer 2 obtained in Example 2.

FIG. 3 is a graph showing the ¹³C NMR spectrum of a highly branched polymer 3 obtained in Example 3.

FIG. 4 is a graph showing the ¹³C NMR spectrum of a highly branched polymer 4 obtained in Example 4.

FIG. 5 is a graph showing the ¹³C NMR spectrum of a highly branched polymer 5 obtained in Example 5.

FIG. 6 is a graph showing the ¹³C NMR spectrum of a highly branched polymer 6 obtained in Example 6.

FIG. 7 is a graph showing the ¹³C NMR spectrum of a highly branched polymer 7 obtained in Example 7.

FIG. 8 is a graph showing the ¹³C NMR spectrum of a highly branched polymer 8 obtained in Reference Example 1.

FIG. 9 is a graph showing the ¹³C NMR spectrum of a highly branched polymer 9 obtained in Reference Example 2.

### MODES FOR CARRYING OUT THE INVENTION

<Fluorine-Containing Highly Branched Polymer>

The fluorine-containing highly branched polymer of the present invention can be obtained by polymerizing a monomer A having in a molecule thereof a bisphenol A structure and two or more radical-polymerizable double bonds, and a monomer B having in a molecule thereof a fluoroalkyl group and at least one radical-polymerizable double bond, in the presence of a polymerization initiator C in an amount of 5 to 200 mol % based on the number of moles of the monomer A. The highly branched polymer is what is called an initiator-fragment incorporation-type highly branched polymer and has at a terminal thereof a fragment of the polymerization initiator C used for the polymerization.

The fluorine-containing highly branched polymer of the present invention may also be copolymerized, if necessary, with another monomer that does not belong to the monomer A and the monomer B unless the effects of the present invention are impaired.

[Monomer A]

In the present invention, it is preferable that the monomer A having in a molecule thereof a bisphenol A structure and two or more radical-polymerizable double bonds contain a bisphenol A structure and have any one of or both of a vinyl group and a (meth)acrylic group. It is particularly preferable that the monomer A be a divinyl compound or a di(meth)acrylate compound containing a bisphenol A structure. It is especially preferable that the monomer A be a compound of Formula [1] below. In the present invention, the (meth)acrylate compound refers to both an acrylate compound and a methacrylate compound. For example, (meth)acrylic acid refers to acrylic acid and methacrylic acid.

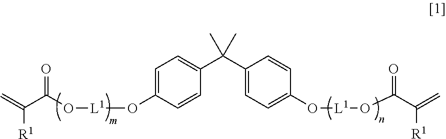

(where R¹ is a hydrogen atom or a methyl group; L¹ are independently a C₁₋₆ alkylene group; and m and n are independently an integer of 0 to 30).

Examples of the C₁₋₆ alkylene group of L¹ include a methylene group, an ethylene group, a trimethylene group, a methylethylene group, a tetramethylene group, a 1-methyltrimethylene group, a pentamethylene group, a 2,2-dimethyltrimethylene group, and a hexamethylene group.

Among them, a methylene group, an ethylene group, and a trimethylene group are preferred.

m and n preferably satisfy an equation: m+n=0 or more and 30 or less.

Examples of such a monomer A include methoxylated bisphenol A di(meth)acrylate, ethoxylated bisphenol A di(meth)acrylate (ethoxy group: 2.3 mol, 2.6 mol, 3 mol, 4 mol, 10 mol, and 17 mol, for example), propoxylated bisphenol A di(meth)acrylate, and propoxylated ethoxylated bisphenol A di(meth)acrylate (propoxy group 12 mol/ethoxy group 6 mol, for example).

Among them, ethoxylated bisphenol A di(meth)acrylate and propoxylated bisphenol A di(meth)acrylate are preferred.

[Monomer B]

In the present invention, it is preferable that the monomer B having in a molecule thereof a fluoroalkyl group and at least one radical-polymerizable double bond have any one of or both of a vinyl group and a (meth)acrylic group. It is particularly preferable that the monomer B be a compound of Formula [2]. It is more preferable that the monomer B be a compound of Formula [3].

Examples of such a monomer B include 2,2,2-trifluoroethyl (meth)acrylate, 2,2,3,3-tetrafluoropropyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, 2-(perfluoro-3-methylbutyl)ethyl (meth)acrylate, 2-(perfluoro-5-methylhexyl)ethyl (meth)acrylate, 2-(perfluoro-7-methyloctyl)ethyl (meth)acrylate, 1H,1H,5H-octafluoropentyl (meth)acrylate, 1H,1H,7H-dodecafluoroheptyl (meth)acrylate, 1H,1H,9H-hexadecafluorononyl (meth)acrylate, 1H-1-(trifluoromethyl)trifluoroethyl (meth)acrylate, 1H,1H,3H-hexafluorobutyl (meth)acrylate, 3-perfluorobutyl-2-hydroxypropyl (meth)acrylate, 3-perfluorohexyl-2-hydroxypropyl (meth)acrylate, 3-perfluorooctyl-2-hydroxypropyl (meth)acrylate, 3-(perfluoro-3-methylbutyl)-2-hydroxypropyl (meth)acrylate, 3-(perfluoro-5-methylhexyl)-2-hydroxypropyl (meth)acrylate, and 3-(perfluoro-7-methyloctyl)-2-hydroxypropyl (meth)acrylate.

In the present invention, the monomer B is used in an amount of preferably 5 to 300 mol %, particularly 10 to 200 mol %, and more preferably 20 to 150 mol % based on the number of moles of the used monomer A from the viewpoint of the reactivity and the surface modifying effect.

[Another Monomer]

The present invention may also contain besides the monomer A and the monomer B, another monomer having in a molecule thereof at least one radical-polymerizable double bond.

The other monomer preferably has any one of or both of a vinyl group and a (meth)acrylic group. Further, from the viewpoint of the dispersibility in (b) the polycarbonate resin, when used in the resin composition, the other monomer is preferably a compound having a benzene ring. Examples of such a monomer include benzyl acrylate, 2-phenoxyethyl acrylate, styrene, and divinylbenzene.

In the present invention, the other monomer is used in an amount of preferably 5 to 300 mol %, particularly 10 to 150 mol %, and more preferably 20 to 100 mol % based on the number of moles of the used monomer A.

[Polymerization Initiator C]

In the present invention, an azo-based polymerization initiator is preferably used as the polymerization initiator C. Examples of the azo-based polymerization initiator include compounds shown in (1) to (5) below.

### (1) Azonitrile Compound:

2,2′-azobisisobutyronitrile, 2,2′-azobis(2-methylbutyronitrile), 2,2′-azobis(2,4-dimethylvaleronitrile), 1,1′-azobis(1-cyclohexanecarbonitrile), 2,2′-azobis(4-methoxy-2,4-dimethylvaleronitrile), 2-(carbamoylazo)isobutyronitrile, etc.

### (2) Azoamide Compound:

2,2′-azobis{2-methyl-N-[1,1-bis(hydroxymethyl)-2-hydroxyethyl]propionamide}, 2,2′-azobis{2-methyl-N-[2-(1-hydroxybutyl)]propionamide}, 2,2′-azobis[2-methyl-N-(2-hydroxyethyl)propionamide], 2,2′-azobis[N-(2-propenyl)-2-methylpropionamide], 2,2′-azobis(N-butyl-2-methylpropionamide), 2,2′-azobis(N-cyclohexyl-2-methylpropionamide), etc.

### (3) Cyclic Azoamidine Compound:

2,2′-azobis[2-(2-imidazolin-2-yl)propane]dihydrochloride, 2,2′-azobis[2-(2-imidazolin-2-yl)propane]disulfate dihydrate, 2,2′-azobis[2-[1-(2-hydroxyethyl)-2-imidazolin-2-yl]propane]dihydrochloride, 2,2′-azobis[2-(2-imidazolin-2-yl)propane], 2,2′-azobis(1-imino-1-pyrrolidino-2-methylpropane) dihydrochloride, etc.

### (4) Azoamidine Compound:

2,2′-azobis(2-methylpropionamidine) dihydrochloride, 2,2′-azobis[N-(2-carboxyethyl)-2-methylpropionamidine]tetrahydrate, etc.

### (5) Others:

dimethyl 2,2′-azobisisobutyrate, 4,4′-azobis(4-cyanovaleric acid), 2,2′-azobis(2,4,4-trimethylpentane), 1,1′-azobis(1-acetoxy-1-phenylethane), dimethyl 1,1′-azobis(1-cyclohexanecarboxylate), 4,4′-azobis(2-(trifluoromethyl)ethyl 4-cyanovalerate), 4,4′-azobis(2-(perfluorobutyl)ethyl 4-cyanovalerate), 4,4′-azobis(2-(perfluorohexyl)ethyl 4-cyanovalerate), etc.

Among the above azo-based polymerization initiators, from the viewpoints of the dispersibility of the obtained highly branched polymer in the component (b) and the surface modification by the component (b), 2,2′-azobis(2-methylbutyronitrile) and dimethyl 2,2′-azobisisobutyrate are preferred and dimethyl 2,2′-azobisisobutyrate is particularly preferred.

The polymerization initiator C is used in an amount of 5 to 200 mol %, preferably 15 to 200 mol %, more preferably 30 to 150 mol %, and further preferably 50 to 150 mol % based on the number of moles of the monomer A.

<Method for Producing Fluorine-Containing Highly Branched Polymer>

The fluorine-containing highly branched polymer of the present invention is obtained by polymerizing the monomer A and the monomer B in the presence of the polymerization initiator C in a predetermined amount relative to the amount of the monomer A. Examples of the polymerization method include publicly known methods such as a solution polymerization, a dispersion polymerization, a precipitation polymerization, and a block polymerization. Among them, the solution polymerization and the precipitation polymerization are preferred. In particular, from the viewpoint of the control of the molecular weight, the reaction is preferably performed by the solution polymerization in an organic solvent.

Examples of the organic solvent used for the polymerization include: aromatic hydrocarbons such as benzene, toluene, xylene, ethylbenzene, and tetralin; aliphatic or alicyclic hydrocarbons such as n-hexane, n-heptane, mineral spirit, and cyclohexane; halides such as methyl chloride, methyl bromide, methyl iodide, dichloromethane, chloroform, carbon tetrachloride, trichloroethylene, perchloroethylene, and o-dichlorobenzene; esters or ester ethers such as ethyl acetate, butyl acetate, methoxybutyl acetate, methylcellosolve acetate, ethylcellosolve acetate, and propylene glycol monomethyl ether acetate; ethers such as diethyl ether, tetrahydrofuran, 1,4-dioxane, methylcellosolve, ethylcellosolve, butylcellosolve, and propylene glycol monomethyl ether; ketones such as acetone, ethyl methyl ketone, isobutyl methyl ketone, di-n-butyl ketone, and cyclohexanone; alcohols such as methanol, ethanol, n-propanol, isopropanol, n-butanol, isobutanol, tert-butanol, 2-ethylhexyl alcohol, and benzyl alcohol; amides such as N,N-dimethylformamide, N,N-dimethylacetamide, and N-methyl-2-pyrrolidone; sulfoxides such as dimethylsulfoxide; and solvent mixtures containing two or more types of these solvents.

Among them, preferred are aromatic hydrocarbons, halides, esters, ester ethers, ethers, ketones, alcohols, amides, and sulfoxides, and particularly preferred are toluene, xylene, o-dichlorobenzene, butyl acetate, propylene glycol monomethyl ether acetate, propylene glycol monomethyl ether, 1,4-dioxane, methylcellosolve, isobutyl methyl ketone, N,N-dimethylformamide, and N,N-dimethylacetamide.

When the polymerization reaction is performed in the presence of an organic solvent, the content of the organic solvent in all of the polymerization reactants is usually 5 to 120 parts by mass, and preferably 10 to 110 parts by mass, relative to 1 part by mass of the monomer A.

The polymerization reaction is performed under normal pressure, under increased pressure in sealed state or under reduced pressure, and from the viewpoint of simplicity of the apparatus and the operation, the polymerization reaction is performed preferably under normal pressure. The polymerization reaction is performed preferably in an atmosphere of an inert gas such as nitrogen.

The temperature for the polymerization reaction is preferably 50 to 200° C., and more preferably 70 to 150° C. or 70 to 130° C. Further preferably, the polymerization reaction is performed at a temperature that is higher than the 10 hour half-life period temperature of the polymerization initiator C by 20° C. or more. More specifically, the polymerization reaction is preferably performed by adding dropwise the solution containing the monomer A, the monomer B, the polymerization initiator C, and an organic solvent to the organic solvent that is maintained at a temperature higher than the 10 hour half-life period temperature of the polymerization initiator C by 20° C. or more. Further preferably, the polymerization reaction is performed at a reflux temperature of the organic solvent under the reaction pressure.

The time for the polymerization reaction varies depending on the reaction temperature, the types and the ratios of the monomer A, the monomer B, and the polymerization initiator C, the type of the polymerization solvent, and the like. Thus, the time for the polymerization reaction cannot be unconditionally specified; however, the time is usually 30 to 720 minutes, and preferably 40 to 540 minutes.

After the completion of the polymerization reaction, the obtained fluorine-containing highly branched polymer is recovered by any methods and, if necessary, is subjected to an after-treatment such as washing. Examples of the method for recovering the polymer from the reaction solution include methods such as reprecipitation.

The obtained fluorine-containing highly branched polymer has a weight average molecular weight (hereinafter, abbreviated as Mw), measured by gel permeation chromatography (GPC) in terms of polystyrene, of preferably 1,000 to 200,000, more preferably 2,000 to 100,000, and most preferably 5,000 to 60,000.

<Method for Producing Varnish and Thin Film>

A specific method for forming a thin film comprising the fluorine-containing highly branched polymer of the present invention includes: dissolving or dispersing the fluorine-containing highly branched polymer in a solvent to prepare a varnish form (film forming material); coating a base material with the varnish by a cast coating method, a spin coating method, a blade coating method, a dip coating method, a roll coating method, a bar coating method, a die coating method, an inkjet method, or a printing method (relief printing, intaglio printing, lithography, screen printing, and other printing methods) to obtain a coating film; and, if necessary, drying the obtained coating film with a hot plate, an oven, or the like for film formation. The varnish comprising the fluorine-containing highly branched polymer is also an object of the present invention.

Among these coating methods, the spin coating method is preferred. The spin coating method enables coating in a short time, and thus has such advantages that even a solution having high volatility can be used and highly homogenous coating can be performed.

Examples of the base material include plastics (polycarbonate, polymethacrylate, polystyrene, polyester, polyolefin, an epoxy, melamine, triacetylcellulose, an acrylonitrile-butadiene-styrene copolymer (ABS) resin, an acrylonitrile-styrene copolymer (AS) resin, a norbornene-based resin, and the like), a metal, a wood, paper, glass, and slate. The shape of the base material may be a plate, a film, or a three-dimensional molded body.

The solvent used for the varnish form may be any solvent so long as the solvent dissolves the fluorine-containing highly branched polymer. Examples of the solvent include: aromatic hydrocarbons such as toluene; esters or ester ethers such as ethyl acetate, butyl acetate, ethyl lactate, γ-butyrolactone, and propylene glycol monomethyl ether acetate (PGMEA); ethers such as tetrahydrofuran (THF), butylcellosolve, diethylene glycol monoethyl ether, propylene glycol monomethyl ether (PGME), propylene glycol monoethyl ether, and hexafluoropropyl hexafluoro-2-pentyl ether; ketones such as acetone, ethyl methyl ketone (MEK), isobutyl methyl ketone (MIBK), and cyclohexanone; alcohols such as methanol and ethanol; and amides such as N,N-dimethylformamide (DMF). These solvents may be used alone or as a mixture of two or more types of them.

Although the concentration of the fluorine-containing highly branched polymer dissolved or dispersed in the above solvent is optional, the concentration of the fluorine-containing highly branched polymer is 0.001 to 90% by mass, preferably 0.002 to 80% by mass, and more preferably 0.005 to 70% by mass, based on the total mass of the fluorine-containing highly branched polymer and the solvent.

Although the thickness of the thin film formed from the fluorine-containing highly branched polymer is not particularly limited, the thickness is usually 0.01 to 50 μm, and preferably 0.05 to 20 μm.

<Method for Modifying Surface>

The present invention also relates to the method for modifying the surface of the polycarbonate resin including kneading the fluorine-containing highly branched polymer with the polycarbonate resin or coating the surface of the polycarbonate resin with the fluorine-containing highly branched polymer.

Polycarbonate resins exemplified in [(b) a polycarbonate resin] to be described below can be used as the polycarbonate resin.

In the coating of the surface of the polycarbonate resin with the fluorine-containing highly branched polymer, the resin surface can be coated with the fluorine-containing highly branched polymer by using any one of varnish forms exemplified in <Method for Producing Varnish and Thin Film> described above and by appropriately using any one of the methods exemplified in the method for producing the thin film.

<Polycarbonate Resin Composition and Molded Article Produced from the Same>

The present invention also relates to a polycarbonate resin composition comprising (a) the fluorine-containing highly branched polymer and (b) the polycarbonate resin.

[(b) Polycarbonate Resin]

Examples of the polycarbonate resin include an aromatic polycarbonate resin in which the carbon directly bonded to the carbonate bond is an aromatic carbon, an aliphatic polycarbonate resin in which the carbon directly bonded to the carbonate bond is an aliphatic carbon, and an aromatic-aliphatic copolymerized polycarbonate containing the both.

The above polycarbonate resins may be used alone or as a mixture of two or more types of them.

In the above polycarbonate resin composition, the blending ratio between (a) the fluorine-containing highly branched polymer and (b) the polycarbonate resin is as follows: the ratio of (a) the fluorine-containing highly branched polymer is preferably 0.01 to 20 parts by mass, and more preferably 0.1 to 20 parts by mass, relative to 100 parts by mass of (b) the polycarbonate resin.

[(c) Solvent]

The polycarbonate resin composition of the present invention may further comprise (c) a solvent.

(c) The solvent may be any solvent so long as the solvent dissolves the component (a) and the component (b). For example, the solvents exemplified in <Method for Producing Varnish and Thin Film> described above can be used. These solvents may be used alone or in combination of two or more types of them.

The concentration of the solid content in the polycarbonate resin composition of the present invention is, for example, 0.5 to 50% by mass, 1 to 30% by mass, or 1 to 20% by mass. Here, the solid content is a component remaining after removing the solvent component from all components of the polycarbonate resin composition.

[Other Additives]

In the above polycarbonate resin composition, an additive that is generally added as needed, such as a flame retardant, a heat stabilizer, an antioxidant, a mold releasing agent, a ultraviolet absorber, a dye and a pigment, a flame retardant, a dripping inhibitor, an antistatic agent, an antifogging agent, a lubricant, an antiblocking agent, a fluidity improving agent, a slidability modifier, a plasticizer, a dispersant, and an antimicrobe agent may be appropriately blended unless the effects of the present invention are impaired. The polycarbonate resin composition may contain two or more types of these additives in any combination and any ratio.

[Method for Producing Polycarbonate Resin Molded Article]

The polycarbonate resin composition of the present invention can be formed into a film, a sheet, or a molded article by any molding method such as injection molding, extrusion molding, press molding, and blow molding.

When the polycarbonate resin composition of the present invention contains a solvent, by coating a base material with the polycarbonate resin composition and drying it, a molded article such as a coating film and a layered product can be produced. As the base material, the base materials having the properties and the shapes exemplified in <Method for Producing Varnish and Thin Film> described above can be used.

As the coating method of the polycarbonate resin composition of the present invention, various coating methods described in <Method for Producing Varnish and Thin Film> described above can be used. The polycarbonate resin composition is preferably filtered beforehand by, for example, using a filter having a pore diameter of around 0.2 μm and then is supplied to the coating.

After the coating, if necessary, the polycarbonate resin composition is heated to remove the solvent in the resin composition, thereby obtaining a coating film. The thus obtained coating film can be used as a surface-modified film.

Although the thickness of the obtained coating film (surface-modified film) is not particularly limited, the thickness of the coating film after being dried is usually 0.1 to 100 μm, and preferably 0.5 to 50 μm.

As described above, the resin molded article including a coating film (surface-modified film) obtained by using the polycarbonate resin composition of the present invention is in such a state where the fluorine-containing highly branched polymer exists in a large amount in the surface (interface) of the molded article in comparison with that in the internal portion (deep portion) of the molded article. Therefore, the resin molded article can be produced as a resin molded article excellent in: mold releasability relative to a mixing machine, a molding machine, and a mold which are used for producing the molded article; peeling properties relative to other resin molded articles such as films; and further water and oil repellency and antifouling properties.

### Example

Hereinafter, the present invention is described more specifically with reference to examples which should not be construed as limiting the scope of the present invention.

In the examples, apparatuses and conditions used for the preparation of the samples and the analysis of the physical properties are as follows:

(1) Gel Permeation Chromatography (GPC)

Apparatus: manufactured by Tosoh Corporation, HLC-8220GPC

Column: manufactured by Showa Denko K.K., Shodex (registered trademark) GPC K-804L, GPC K-805L

Column temperature: 40° C.

Solvent: tetrahydrofuran

Detector: RI

(2)¹³C NMR Spectrum

Apparatus: manufactured by JEOL Datum Ltd., JNM-ECA700

Solvent: CDCl₃

Standard: CDCl₃ (77.0 ppm)

(3) Measurement of Glass Transition Temperature (Tg)

Apparatus: manufactured by NETZSCH Companies, DSC 204 F1 Phoenix (registered trademark)

Measuring condition: in nitrogen atmosphere

Temperature raising rate: 5° C./min (25 to 200° C.)

(4) Measurement of Temperature (Td_{5 %}) at which Weight Decreases by 5%

Apparatus: manufactured by Bruker AXS K.K., Thermogravimetric/Differential Thermal Analyzer TG-DTA2000SA

Measuring condition: in air atmosphere

Temperature raising rate: 10° C./min (25 to 400° C.)

(5) F Determining Analysis (Ion Chromatography)

Apparatus: manufactured by Nippon Dionex K.K., ICS-1500

Solvent: (2.7 mmol/L sodium carbonate and 0.3 mmol/L sodium bicarbonate) aqueous solution

Detector: electric conductivity meter

(6) Spin Coater

Apparatus: manufactured by Mikasa Co., Ltd., MS-A100

(7) Doctor Blade Coating

Apparatus: manufactured by Yoshimitsu Seiki Co., Ltd., Doctor blade YD-1 type 100 μm

(8) Hot Plate

Apparatus: manufactured by AS ONE Corporation, MH-180CS+MH-3CS

(9) Measurement of Contact Angle

Apparatus: manufactured by Kyowa Interface Science Co., Ltd., DM-501

Measurement temperature: 25° C.

(10) Measurement of HAZE

Apparatus: manufactured by NIPPON DENSHOKU INDUSTRIES CO., LTD., HAZE meter NDH 5000.

Abbreviations mean the followings.

BPM: 2,2-bis(4-(2-methacryloyloxyethoxyl)phenyl)propane (ethoxy group: 2.6 mol) [manufactured by Shin-Nakamura Chemical Co., Ltd., BPE-100]
C6FA: 2-(perfluorohexyl) ethylacrylate [manufactured by UNIMATEC CO., LTD., FAAC-6]
BA: benzyl acrylate [manufactured by Osaka Organic Chemical Industry Ltd., Viscoat #160]
PEA: 2-phenoxyethyl acrylate [manufactured by Osaka Organic Chemical Industry Ltd., Viscoat #192]
St: styrene [manufactured by Tokyo Chemical Industry Co., Ltd.]
DVB: divinylbenzene [manufactured by Nippon Steel Chemical Co., Ltd., DVB-960]
EGDMA: ethylene glycol dimethacrylate [manufactured by Shin-Nakamura Chemical Co., Ltd., 1G]
MAIB: dimethyl 2,2′-azobisisobutyrate [manufactured by Otsuka Chemical Co., Ltd., MAIB]
CM1000: polycarbonate [manufactured by Teijin Chemicals Ltd., CM-1000]
MIBK: isobutyl methyl ketone
THF: tetrahydrofuran
MEK: ethyl methyl ketone

### Example 1

### Production of Highly Branched Polymer 1 Using BPM, C6FA, and MAIB

Into a 200 mL reaction flask, 57 g of MIBK was charged. While MIBK was stirred, nitrogen was flown into the reaction flask for 5 minutes, followed by heating the inner liquid of the reaction flask until the inner liquid was refluxed (to about 116° C.).

Into another 100 mL reaction flask, 4.8 g (10 mmol) of BPM as the monomer A, 4.2 g (10 mmol) of C6FA as the monomer B, 1.4 g (6 mmol) of MAIB as the polymerization initiator C, and 57 g of MIBK were charged. While the resultant reaction mixture was stirred, nitrogen was flown into the reaction flask for 5 minutes to purge the inside of the reaction flask with nitrogen, followed by cooling down the reaction mixture to 0° C. using an ice bath.

To MIBK that had been refluxed in the above 200 mL reaction flask, the content of the above 100 mL reaction flask into which BPM, C6FA, and MAIB had been charged was added dropwise using a dropping pump over 30 minutes. After the completion of the dropwise-addition, the resultant reaction mixture was stirred further for 1 hour.

Next, from the resultant reaction liquid, about 80% (91 g) of the charged MIBK was distilled off using a rotary evaporator, and then, the resultant reaction mixture was added to 239 g of methanol cooled down to about 5° C. to precipitate a polymer in a slurry state. The slurry was filtered under reduced pressure and the filtration residue was vacuum dried to obtain 4.0 g of the objective substance (highly branched polymer 1) as a white powder.

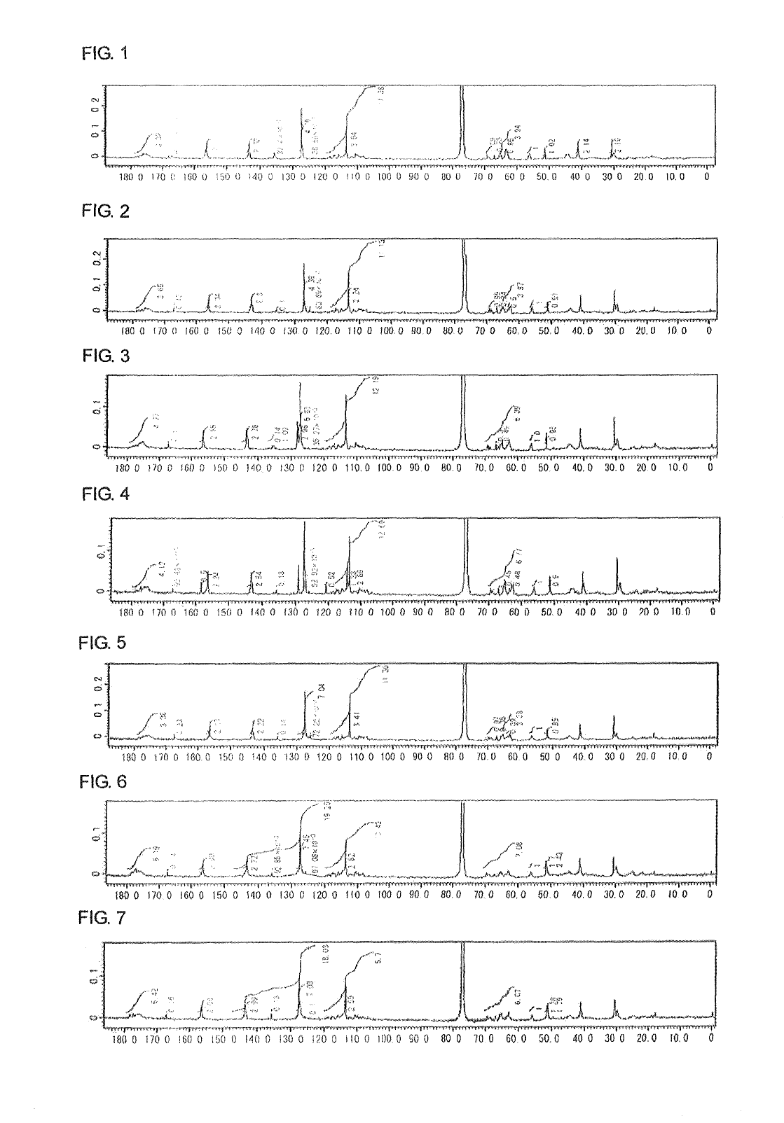

The obtained objective substance had a weight average molecular weight Mw of 9,900 and a degree of distribution Mw (weight average molecular weight)/Mn (number average molecular weight) of 1.9, which were measured by GPC in terms of polystyrene. FIG. 1 shows the ¹³C NMR spectrum of the objective substance.

### Example 2

### Production of Highly Branched Polymer 2 Using BPM, C6FA, and MAIB

The polymerization and the purification were performed in the same manner as in Example 1, except that the used amount of MAIB was changed to 1.2 g (5 mmol) and each amount of MIBK used was changed to 48 g, to obtain 8.0 g of the objective substance (highly branched polymer 2) as a white powder.

The obtained objective substance had a weight average molecular weight Mw of 11,000 and a degree of distribution Mw/Mn of 2.9, which were measured by GPC in terms of polystyrene. FIG. 2 shows the ¹³C NMR spectrum of the objective substance.

### Example 3

### Production of Highly Branched Polymer 3 Using BPM, C6FA, BA, and MAIB

The polymerization and the purification were performed in the same manner as in Example 1, except that, as another monomer, 0.8 g (5 mmol) of BA was added together with the monomers A and B and each amount of MIBK used was changed to 72 g, to obtain 6.0 g of the objective substance (highly branched polymer 3) as a white powder.

The obtained objective substance had a weight average molecular weight Mw of 6,500 and a degree of distribution Mw/Mn of 2.4, which were measured by GPC in terms of polystyrene. FIG. 3 shows the ¹³C NMR spectrum of the objective substance.

### Example 4

### Production of Highly Branched Polymer 4 Using BPM, C6FA, PEA, and MAIB

The polymerization and the purification were performed in the same manner as in Example 1, except that, as another monomer, 1.0 g (5 mmol) of PEA was added together with the monomers A and B and each amount of MIBK used was changed to 72 g, to obtain 8.5 g of the objective substance (highly branched polymer 4) as a white powder.

The obtained objective substance had a weight average molecular weight Mw of 6,600 and a degree of distribution Mw/Mn of 2.5, which were measured by GPC in terms of polystyrene. FIG. 4 shows the ¹³C NMR spectrum of the objective substance.

### Example 5

### Production of Highly Branched Polymer 5 Using BPM, C6FA, St, and MAIB

The polymerization and the purification were performed in the same manner as in Example 1, except that, as another monomer, 0.5 g (5 mmol) of St was added together with the monomers A and B and each amount of MIBK used was changed to 72 g, to obtain 6.8 g of the objective substance (highly branched polymer 5) as a white powder.

The obtained objective substance had a weight average molecular weight Mw of 7,300 and a degree of distribution Mw/Mn of 2.5, which were measured by GPC in terms of polystyrene. FIG. 5 shows the ¹³C NMR spectrum of the objective substance.

### Example 6

### Production of Highly Branched Polymer 6 Using BPM, C6FA, DVB, and MAIB

The polymerization and the purification were performed in the same manner as in Example 1, except that, as another monomer, 1.3 g (10 mmol) of DVB was added together with the monomers A and B, the used amount of MAIB was changed to 2.8 g (12 mmol) and each amount of MIBK used was changed to 72 g, to obtain 10.0 g of the objective substance (highly branched polymer 6) as a white powder.

The obtained objective substance had a weight average molecular weight Mw of 10,000 and a degree of distribution Mw/Mn of 2.5, which were measured by GPC in terms of polystyrene. FIG. 6 shows the ¹³C NMR spectrum of the objective substance.

### Example 7

### Production of Highly Branched Polymer 7 Using BPM, C6FA, DVB, and MAIB

The polymerization and the purification were performed in the same manner as in Example 1, except that, as another monomer, 0.7 g (5 mmol) of DVB was added together with the monomers A and B, the used amount of MAIB was changed to 2.1 g (9 mmol), and each amount of MIBK used was changed to 109 g, to obtain 8.4 g of the objective substance (highly branched polymer 7) as a white powder.

The obtained objective substance had a weight average molecular weight Mw of 7,800 and a degree of distribution Mw/Mn of 2.4, which were measured by GPC in terms of polystyrene. FIG. 7 shows the ¹³C NMR spectrum of the objective substance.

### Reference Example 1

### Production of Highly Branched Polymer 8 Using EGDMA, C6FA, and MAIB

Into a 200 mL reaction flask, 32 g of toluene was charged. While the toluene was stirred, nitrogen was flown into the reaction flask for 5 minutes, followed by heating the inner liquid of the reaction flask until the inner liquid was refluxed (to about 110° C.).

Into another 100 mL reaction flask, 4.0 g (20 mmol) of EGDMA as the monomer A, 4.2 g (10 mmol) of C6FA as the monomer B, 2.3 g (10 mmol) of MAIB as the polymerization initiator C, and 32 g of toluene were charged. While the resultant reaction mixture was stirred, nitrogen was flown into the reaction flask for 5 minutes to purge the inside of the reaction flask with nitrogen, followed by cooling down the reaction mixture to 0° C. using an ice bath.

To the toluene that had been refluxed in the above 200 mL reaction flask, the content of the above 100 mL reaction flask into which EGDMA, C6FA, and MAIB had been charged was added dropwise using a dropping pump over 30 minutes. After the completion of the dropwise-addition, the resultant reaction mixture was stirred further for 1 hour.

Next, the resultant reaction liquid was added to 277 g of a mixed liquid of hexane/toluene (mass ratio: 4:1) to precipitate a polymer in a slurry state. The slurry was filtered under reduced pressure and the obtained crude product was dissolved in 36 g of THF. The resultant solution was added to 277 g of hexane to precipitate a polymer in a slurry state. The slurry was filtered under reduced pressure and the filtration residue was vacuum dried to obtain 4.9 g of the objective substance (highly branched polymer 8) as a white powder.

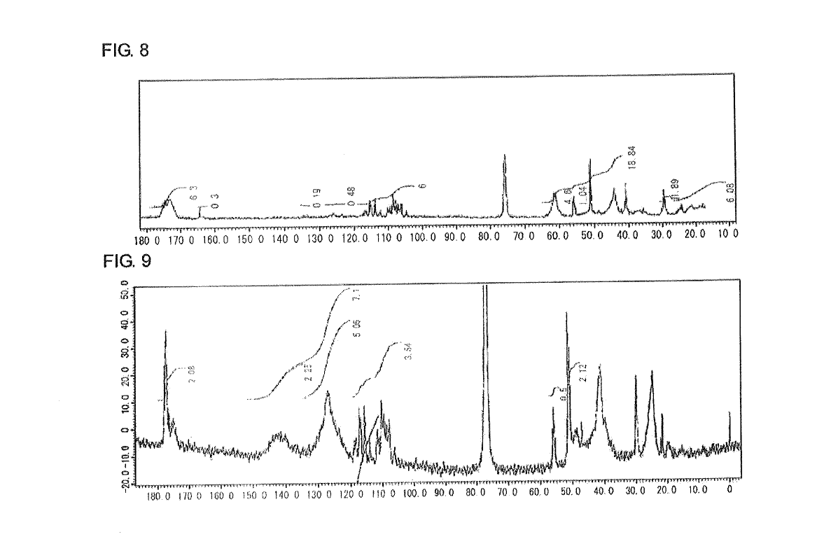

The obtained objective substance had a weight average molecular weight Mw of 17,000 and a degree of distribution Mw/Mn of 2.2, which were measured by GPC in terms of polystyrene. FIG. 8 shows the ¹³C NMR spectrum of the objective substance.

### Reference Example 2

### Production of Highly Branched Polymer 9 Using DVB, C6FA, and MAIB

Into a 2 L reaction flask, 521 g of MIBK was charged. While MIBK was stirred, nitrogen was flown into the reaction flask for 5 minutes, followed by heating the inner liquid of the reaction flask until the inner liquid was refluxed (to about 116° C.).

Into another 1 L reaction flask, 26 g (200 mmol) of DVB as the monomer A, 42 g (100 mmol) of C6FA as the monomer B, 55 g (240 mmol) of MAIB as the polymerization initiator C, and 521 g of MIBK were charged. While the resultant reaction mixture was stirred, nitrogen was flown into the reaction flask for 5 minutes to purge the inside of the reaction flask with nitrogen, followed by cooling down the reaction mixture to 0° C. using an ice bath.

To MIBK that had been refluxed in the above 2 L reaction flask, the content of the above 1 L reaction flask into which DVB, C6FA, and MAIB had been charged was added dropwise using a dropping pump over 30 minutes. After the completion of the dropwise-addition, the resultant reaction mixture was stirred further for 1 hour.

Next, the resultant reaction liquid was added to 1,300 g of methanol to precipitate a polymer in a slurry state. The slurry was filtered under reduced pressure and the filtration residue was vacuum dried to obtain 44 g of the objective substance (highly branched polymer 9) as a white powder.

The obtained objective substance had a weight average molecular weight Mw of 8,800 and a degree of distribution Mw/Mn of 1.5, which were measured by GPC in terms of polystyrene. FIG. 9 shows the ¹³C NMR spectrum of the objective substance.

Table 1 summarizes the following data regarding the highly branched polymers 1 to 9 obtained in Examples 1 to 7 and Reference Examples 1 and 2. Table 1 shows the type of each monomer and the charged amount [mol %] of each monomer relative to that of the monomer A, the charged amount [mol %] of the polymerization initiator C relative to that of the monomer A, the weight average molecular weight Mw, the degree of distribution Mw/Mn, the glass transition temperature Tg [° C.], the temperature at which the weight decreases by 5% Td_{5 %}[° C.], the introduced amount [mol %] of the monomer B calculated from the ¹³C NMR spectrum, and the F atom content [% by mass] calculated from the F determining analysis.

TABLE 1

| | | C6FA | | | MAIB | | | | | C6FA | F atom |
|---|---|---|---|---|---|---|---|---|---|---|---|
| Highly | | charged | Other monomer | | charged | | | | | introduced | content |
| branched | | amount | | Charged | amount | | Mw/ | Tg | Td_{5%} | amount | [% by |
| polymer | Monomer A | [mol %] | Type | amount | [mol %] | Mw | Mn | [° C.] | [° C.] | [mol %] | mass] |
| 1 | BPM | 100 | — | — | 60 | 9,900 | 1.9 | 49.9 | 289.2 | 38 | 22 |
| 2 | BPM | 100 | — | — | 50 | 11,000 | 2.9 | 38.8 | 283.7 | 40 | 22 |
| 3 | BPM | 100 | BA | 50 | 60 | 6,500 | 2.4 | 74.7 | 281.0 | 30 | 19 |
| 4 | BPM | 100 | PEA | 50 | 60 | 6,600 | 2.5 | 42.9 | 281.6 | 31 | 19 |
| 5 | BPM | 100 | St | 50 | 60 | 7,300 | 2.5 | 36.6 | 283.2 | 35 | 20 |
| 6 | BPM | 100 | DVB | 100 | 120 | 10,000 | 2.5 | 52.1 | 306.2 | 22 | 16 |
| 7 | BPM | 100 | DVB | 50 | 90 | 7,800 | 2.4 | 41.7 | 291.5 | 26 | 17 |
| 8 | EGDMA | 50 | — | — | 50 | 17,000 | 2.2 | 79.6 | 272.1 | 25 | 25 |
| 9 | DVB | 50 | — | — | 120 | 8,800 | 1.5 | 58.3 | 279.8 | 17 | 24 |

### Example 8

### Solvent Solubility of Highly Branched Polymers 1 to 7

The highly branched polymers 1 to 7 obtained in Examples 1 to 7, respectively, were evaluated with respect to the solubility in each solvent shown in Table 2. The evaluation was performed as follows: the highly branched polymers were each mixed with each of the solvents so that the concentration of the polymer in the solvent reaches 10% by mass; the resultant mixture was stirred at 25° C. for 5 minutes; and then the solubility of the polymer in the solvent was visually evaluated according to the evaluation criteria below. The evaluation results are summarized in Table 2.

### [Evaluation Criteria]

◯: The mixture became a transparent solution and the polymer was dissolved satisfactorily.

x: Undissolved substances remained.

### Comparative Example 1

### Solvent Solubility of Highly Branched Polymers 8 and 9

The highly branched polymers 8 and 9 obtained in Reference Examples 1 and 2, respectively, were evaluated in the same manner as in Example 8. The evaluation results are summarized in Table 2.

TABLE 2

| | | | | | Chloro- |
|---|---|---|---|---|---|
| | Toluene | Acetone | MEK | THF | form |
| Highly branched polymer 1 | ◯ | ◯ | ◯ | ◯ | ◯ |
| Highly branched polymer 2 | ◯ | ◯ | ◯ | ◯ | ◯ |
| Highly branched polymer 3 | ◯ | ◯ | ◯ | ◯ | ◯ |
| Highly branched polymer 4 | ◯ | ◯ | ◯ | ◯ | ◯ |
| Highly branched polymer 5 | ◯ | ◯ | ◯ | ◯ | ◯ |
| Highly branched polymer 6 | ◯ | ◯ | ◯ | ◯ | ◯ |
| Highly branched polymer 7 | ◯ | ◯ | ◯ | ◯ | ◯ |
| Highly branched polymer 8 | ◯ | ◯ | ◯ | ◯ | ◯ |
| Highly branched polymer 9 | ◯ | ◯ | ◯ | ◯ | ◯ |

### Example 9

### Preparation of Single Thin Film Using Each of Highly Branched Polymers 1 to 7 and Evaluation of its Physical Property

A solution of each of the highly branched polymers 1 to 7 obtained in Examples 1 to 7, respectively, in toluene that had a concentration of the polymer of 5% by mass was prepared and was filtered with a filter to prepare a varnish of each highly branched polymer. A silicon wafer was spin-coated (slope: 5 seconds, 1,500 rpm×30 seconds, slope: 5 seconds) with the varnish, and the varnish was heated on a hot plate at 100° C. for 30 minutes to remove the solvent to prepare a thin film.

The contact angles of the obtained thin film with water and diiodomethane were evaluated. From the results of the contact angle evaluation, the surface energy was calculated. The obtained results are summarized in Table 3.

### Comparative Example 2

### Preparation of Single Thin Film Using Each of Highly Branched Polymers 8 and 9 and Evaluation of its Physical Property

The thin films of the highly branched polymers 8 and 9 obtained in Reference Examples 1 and 2, respectively, were prepared and evaluated in the same manner as in Example 9. The results of the evaluation are summarized in Table 3.

TABLE 3

| | Contact angle [degrees] | | Surface energy |
|---|---|---|---|
| | H₂O | CH₂I₂ | [mJ/m²] |
| Highly branched polymer 1 | 102.9 | 64.9 | 25.8 |
| Highly branched polymer 2 | 106.5 | 76.8 | 19.2 |
| Highly branched polymer 3 | 104.5 | 74.9 | 20.3 |
| Highly branched polymer 4 | 106.1 | 72.4 | 21.5 |
| Highly branched polymer 5 | 106.1 | 76.9 | 19.1 |
| Highly branched polymer 6 | 102.2 | 60.2 | 28.6 |
| Highly branched polymer 7 | 103.9 | 53.2 | 33.1 |
| Highly branched polymer 8 | 104.4 | 76.1 | 19.6 |
| Highly branched polymer 9 | 101.7 | 72.7 | 21.5 |

### Examples 10 to 17

### Surface Modification of Polycarbonate Resin Using Highly Branched Polymer

100 parts by mass of CM 1000 that is a polycarbonate resin was dissolved in 900 parts by mass of THF. To the resultant solution, each of the highly branched polymers 1 to 7 as a predetermined surface modifier listed in Table 4, was added to prepare a varnish of a polycarbonate resin composition.

A glass substrate of 10 cm×20 cm was coated with the obtained varnish using a doctor blade. The resultant coating film was heated on a hot plate at 100° C. for 5 minutes to remove the solvent to prepare a polycarbonate resin film having a thickness of 10 μm.

The contact angles of the obtained resin film with water and oleic acid were measured. In addition, the HAZE of each of the resin films was measured and the transparency of the resin film was evaluated according to the evaluation criteria below. The results are summarized in Table 4.

### [Evaluation Criteria]

⊙: 0≦HAZE<0.35

◯: 0.35≦HAZE<0.5

Δ: 0.5≦HAZE<1.0

x: 1.0≦HAZE

### Comparative Example 3

### Physical Properties of Polycarbonate Resin Film to which No Surface Modifier is Added

A polycarbonate resin film was prepared in the same manner as in Example 10 except that the surface modifier (highly branched polymer) was not added, and the prepared polycarbonate resin film was evaluated in the same manner as in Example 10. The results are summarized in Table 4.

### Comparative Examples 4 and 5

### Surface Modification of Polycarbonate Resin Using Highly Branched Polymer Having No Bisphenol a Structure

Polycarbonate resin films were prepared in the same manner as in Example 10 except that each of the highly branched polymers 8 and 9 was added as the surface modifier, and the prepared polycarbonate resin films were evaluated in the same manner as in Example 10. The results are summarized in Table 4.

TABLE 4

| | Surface modifier | | | | |
|---|---|---|---|---|---|
| | | Added | Contact angle | | |
| | | amount | [degrees] | | |
| | | [parts by | | Oleic | Trans- |
| | Type | mass] | H₂O | acid | parency |
| Example 10 | Highly branched | 1 | 104.4 | 67.5 | ⊙ |
| | polymer 1 | | | | |
| Example 11 | Highly branched | 1 | 105.1 | 68.0 | ⊙ |
| | polymer 2 | | | | |
| Example 12 | Highly branched | 1 | 102.2 | 60.8 | ⊙ |
| | polymer 3 | | | | |
| Example 13 | Highly branched | 1 | 100.9 | 57.7 | ⊙ |
| | polymer 4 | | | | |
| Example 14 | Highly branched | 1 | 99.1 | 59.1 | ◯ |
| | polymer 5 | | | | |
| Example 15 | Highly branched | 1 | 97.7 | 55.6 | ⊙ |
| | polymer 6 | | | | |
| Example 16 | Highly branched | 1 | 99.0 | 58.9 | ⊙ |
| | polymer 7 | | | | |
| Example 17 | Highly branched | 3 | 104.2 | 68.9 | ◯ |
| | polymer 7 | | | | |
| Comparative | None | — | 84.2 | 9.7 | ◯ |
| Example 3 | | | | | |
| Comparative | Highly branched | 1 | 99.2 | 63.2 | X |
| Example 4 | polymer 8 | | | | |
| Comparative | Highly branched | 1 | 100.6 | 61.2 | Δ |
| Example 5 | polymer 9 | | | | |

From the results shown in Table 4, a polycarbonate resin film containing no surface modifier exhibited a contact angle with water of 84.2 degrees and a contact angle with oleic acid of 9.7 degrees (Comparative Example 3). In contrast, the polycarbonate resin film in which the highly branched polymer of the present invention was added as a surface modifier exhibited such high contact angles as a contact angle with water of 99.0 to 105.1 degrees and a contact angle with oleic acid of 55.6 to 68.9 degrees (Examples 10 to 17). In addition, the polycarbonate resin film exhibited also transparency equal to or higher than that of a polycarbonate resin film containing no surface modifier. On the other hand, although a polycarbonate resin film in which a highly branched polymer having no bisphenol A structure was added as a surface modifier exhibited a high contact angle with water and a high contact angle with oleic acid, the polycarbonate resin film exhibited transparency lower than that of the polycarbonate resin film in which no surface modifier was added (Comparative Examples 4 and 5).

It is apparent from these results that by adding the highly branched polymer of the present invention to a polycarbonate resin, water and oil repellency can be imparted to a resin film obtained from the resin without impairing the inherent transparency of the resin.

1. A fluorine-containing highly branched polymer obtained by polymerizing a monomer A having in a molecule a bisphenol A structure and two or more radical-polymerizable double bonds, and a monomer B having in a molecule a fluoroalkyl group and at least one radical-polymerizable double bond, in the presence of a polymerization initiator C in an amount of 5 to 200 mol %, based on the number of moles of the monomer A.

2. The fluorine-containing highly branched polymer according to claim 1, wherein
the monomer A is a compound having either a vinyl group or a (meth)acrylic group or both a vinyl group and a (meth)acrylic group.

3. The fluorine-containing highly branched polymer according to claim 2, wherein
the monomer A is a divinyl compound or a di(meth)acrylate compound.

4. The fluorine-containing highly branched polymer according to claim 3, wherein
the monomer A is a compound of Formula [1]: 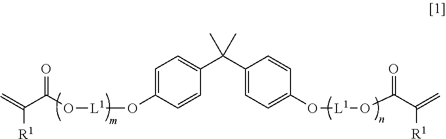
(where R¹ is a hydrogen atom or a methyl group; L¹ are independently a C₁₋₆ alkylene group; and m and n are independently an integer of 0 to 30).

5. The fluorine-containing highly branched polymer according to claim 1, wherein
the monomer B is a compound having at least one of either a vinyl group or a (meth)acrylic group.

6. The fluorine-containing highly branched polymer according to claim 5, wherein
the monomer B is a compound of Formula [2]: 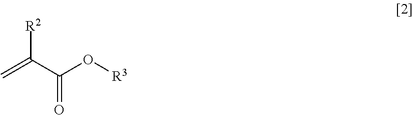
(where R² is a hydrogen atom or a methyl group; and R³ is a C₂₋₁₂ fluoroalkyl group optionally substituted with a hydroxy group).

7. The fluorine-containing highly branched polymer according to claim 6, wherein
the monomer B is a compound of Formula [3]: 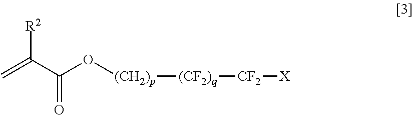
(where R² means the same as defined in Formula [2]; X is a hydrogen atom or a fluorine atom; and p is 1 or 2; and q is an integer of 0 to 5).

8. The fluorine-containing highly branched polymer according to claim 1, wherein
the monomer A is a compound of Formula [1]; and
the monomer B is a compound of Formula [2]: 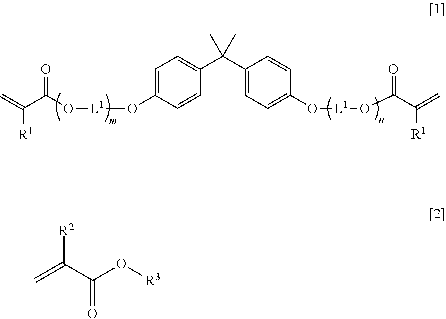
(where R¹ and R² are independently a hydrogen atom or a methyl group; R³ is a C₂₋₁₂ fluoroalkyl group optionally substituted with a hydroxy group; L¹ independently a C₁₋₆ alkylene group; and m and n are independently an integer of 0 to 30).

9. The fluorine-containing highly branched polymer according to claim 1, wherein
the polymerization initiator C is an azo-based polymerization initiator.

10. The fluorine-containing highly branched polymer according to claim 9, wherein
the polymerization initiator C is dimethyl 2,2′-azobisisobutyrate or 2,2′-azobis(2-methylbutyronitrile).

11. The fluorine-containing highly branched polymer according to claim 1, wherein
the fluorine-containing highly branched polymer is obtained by using the monomer B in an amount of 5 to 300 mol %, based on the number of moles of the monomer A.

12. A varnish comprising:
the fluorine-containing highly branched polymer as claimed in claim 1.

13. A thin film comprising:
the fluorine-containing highly branched polymer as claimed in claim 1.

14. A method for modifying a surface of a polycarbonate resin, the method comprising:
kneading the fluorine-containing highly branched polymer as claimed in claim 1 with the polycarbonate resin, or coating the surface of the resin with the fluorine-containing highly branched polymer.

15. A resin composition comprising:
(a) the fluorine-containing highly branched polymer as claimed in claim 1; and
(b) a polycarbonate resin.

16. The resin composition according to claim 15, wherein
a content of (a) the fluorine-containing highly branched polymer is 0.01 to 20 parts by mass, relative to 100 parts by mass of (b) the polycarbonate resin.

17. The resin composition according to claim 16, further comprising (c) a solvent.

18. A surface-modified film obtained from the resin composition as claimed in claim 15.

19. The surface-modified film according to claim 18, wherein
the surface-modified film has a film thickness of 0.1 to 100 μm.

20. A method for forming a surface-modified film, the method comprising:
coating a surface of a base material with the resin composition as claimed in claim 17 to form a coating film; and
drying the coating film to remove the solvent.

21. The method according to claim 20, wherein
the surface-modified film has a film thickness of 0.1 to 100 μm.
